(19) United States
(12) Patent Application Publication
(10) Pub. No.: US 2016/0209782 A1
(43) Pub. Date: Jul. 21, 2016

(54) IMAGE FORMING APPARATUS

(71) Applicant: FUNAI ELECTRIC CO., LTD., Osaka (JP)

(72) Inventor: Masami SHIRATORI, Moriguchi-shi (JP)

(21) Appl. No.: 14/916,631

(22) PCT Filed: May 8, 2014
(86) PCT No.: PCT/JP2014/062302

§ 371 Date: Mar. 4, 2016

(30) Foreign Application Priority Data
Sep. 5, 2013 (JP) 2013-183844

(51) Int. Cl. G03G 15/16

(52) U.S. Cl. CPC G03G 15/167

(57) ABSTRACT

This image forming apparatus (100) includes a transfer body (8) that is arranged in an apparatus body and transfers an image of an image carrier (70) to a recording medium while pressing the image carrier through the recording medium, and the transfer body is mounted on the apparatus body to be detachable from the apparatus body to a side opposite to a pressing direction in which the transfer body presses the image carrier.

### TECHNICAL FIELD

The present invention relates to an image forming apparatus, and more particularly, it relates to an image forming apparatus including an image carrier and a transfer body that transfers an image of the image carrier to a recording medium while pressing the image carrier.

### BACKGROUND ART

An image forming apparatus including an image carrier and a transfer body that transfers an image of the image carrier to a recording medium while pressing the image carrier is known in general. Such an image forming apparatus is disclosed in Japanese Patent Laying-Open No. 2000-122448, for example.

In Japanese Patent Laying-Open No. 2000-122448, there is disclosed an image forming apparatus including an image carrier, a transfer roller (transfer body) that transfers an image on the image carrier to a transfer member through a transfer nip between the image carrier and the transfer roller, and a discharger that discharges the transfer member after the image transfer. In this image forming apparatus described in Japanese Patent Laying-Open No. 2000-122448, the transfer roller is rotatably mounted on the inner surface of a cover member (a member that forms the outer shape of an apparatus body) mounted so that the cover member is openable and closable, covering a side surface of the apparatus body.

### PRIOR ART

### Patent Document

### Patent Document 1: Japanese Patent Laying-Open No. 2000-122448

### SUMMARY OF THE INVENTION

### Problem to be Solved by the Invention

In the image forming apparatus described in Japanese Patent Laying-Open No. 2000-122448, however, the transfer roller is mounted on the inner surface of the cover member mounted on the apparatus body so that the cover member is openable and closable, and hence it is conceivably necessary to ensure strength for rotatably holding the transfer roller in the cover member.

As another conventional example, an image forming apparatus including an image carrier, configured such that a transfer roller is detached through a space obtained by detaching a development unit after the development unit that develops an image is detached from an apparatus body is also known in general. In the aforementioned image forming apparatus configured such that the transfer roller is detached through the space obtained by detaching the development unit, however, it is necessary for a user to put his/her hand in the apparatus body, and hence the user may have trouble replacing the transfer roller. In this case, there is such a problem that the user cannot easily replace the transfer roller.

The present invention has been proposed in order to solve the aforementioned problem, and one object of the present invention is to provide an image forming apparatus including an image carrier and a transfer body that transfers an image of the image carrier to a recording medium while pressing the image carrier, in which the transfer body can be easily replaced without unnecessarily increasing the strength of a cover member or the like that forms the outer shape of an apparatus body.

### Means for Solving the Problem

An image forming apparatus according to an aspect of the present invention includes an apparatus body, an image carrier rotatably provided in the apparatus body, and a transfer body that is arranged in the apparatus body and transfers an image of the image carrier to a recording medium while pressing the image carrier through the recording medium, and the transfer body is mounted on the apparatus body to be detachable from the apparatus body to a side opposite to a pressing direction in which the transfer body presses the image carrier.

In the image forming apparatus according to this aspect of the present invention, as hereinabove described, the transfer body is mounted on the apparatus body to be detachable from the apparatus body to the side opposite to the pressing direction in which the transfer body presses the image carrier, whereby the transfer body can be detached from the inside of the apparatus body without moving the position of the image carrier, and hence the transfer body can be easily replaced unlike the apparatus structure in which the transfer body is detached in the pressing direction to the image carrier after the position of the image carrier is moved. Furthermore, the transfer body can be detached from the inside of the apparatus body, and hence it is not necessary to provide the transfer body on a cover member (casing) or the like that forms the outer shape of the apparatus body. Thus, an unnecessary increase of the strength of a portion closer to the outer shape of the apparatus body resulting from holding the transfer body can be significantly reduced or prevented.

The aforementioned image forming apparatus according to this aspect preferably further includes a holding portion that is arranged closer to the apparatus body and is capable of holding the pressing of the transfer body to the image carrier, and the transfer body is preferably detachable from the apparatus body to the side opposite to the pressing direction by opening the holding portion to the side opposite to the pressing direction. According to this structure, the holding portion can be opened to the side opposite to the pressing direction of the transfer body, and hence the transfer body can be easily replaced. Furthermore, the transfer body can be held in a prescribed position by the holding portion arranged closer to the apparatus body as a member separate from the apparatus body, and hence it is not necessary for the cover member (casing) or the like that forms the outer shape of the apparatus body to hold the transfer body. In other words, it is not necessary to strongly form the cover member (casing) or the like that forms the outer shape of the apparatus body so as to hold the transfer body, and hence an unnecessary increase of the strength of the cover member (casing) or the like that forms the outer shape of the apparatus body can be significantly reduced or prevented.

In this case, the holding portion is preferably rotatably mounted on the apparatus body, and the transfer body is preferably detached from the apparatus body to the side opposite to the pressing direction by rotating the holding portion to the side opposite to the pressing direction of the transfer body to the image carrier about a rotation center. According to this structure, the holding portion can be rotated to the side opposite to the pressing direction of the transfer body, and hence the holding portion can be opened by a simple mechanism. Thus, the transfer body can be easily detached from the apparatus body.

In the aforementioned image forming apparatus including the holding portion, the holding portion preferably includes a pair of holding portions on a first side and a second side in the rotation axis direction of the transfer body. According to this structure, the holding portions can stably hold the pressing of the transfer body to the image carrier unlike the case where one holding portion is provided.

In the aforementioned structure including the holding portion capable of holding the pressing of the transfer body to the image carrier, the holding portion preferably includes an engagement portion that engages with the apparatus body, and the transfer body is preferably detached from the apparatus body to the side opposite to the pressing direction by releasing the engagement of the engagement portion. According to this structure, the apparatus body and the holding portion can be fixed to each other through the engagement portion. Furthermore, the holding portion can be opened by releasing the engagement of the engagement portion, and hence the transfer body can be easily detached from the apparatus body.

In this case, the apparatus body preferably includes a locking portion that engages with the engagement portion of the holding portion, and the holding portion preferably further includes a handle portion that is provided integrally with the engagement portion and releases engagement between the engagement portion and the locking portion by elastic deformation. According to this structure, the engagement between the engagement portion and the locking portion can be easily released by the handle portion.

In the aforementioned image forming apparatus in which the holding portion includes the engagement portion, the holding portion preferably includes a pair of holding portions on a first side and a second side in the rotation axis direction of the transfer body, and the engagement portion is preferably provided in each of the pair of holding portions. According to this structure, the pressing of the transfer body to the image carrier can be stably held unlike the case where one holding portion and one engagement portion are provided.

In this case, the apparatus body preferably includes a first locking portion that engages with the engagement portion of the holding portion and is capable of locking the holding portion in a state where the transfer body is pressed to the image carrier and a second locking portion that engages with the engagement portion of the holding portion and is capable of locking the holding portion in a state where the pressing of the transfer body to the image carrier is released. According to this structure, the second locking portion engages with the engagement portion such that a small space can be ensured between the transfer body and the image carrier, and hence paper (recording medium) held between the transfer body and the image carrier can be easily pulled out when a jam of the paper occurs.

In the aforementioned image forming apparatus in which the apparatus body includes the first locking portion and the second locking portion, the second locking portion is preferably arranged in a direction in which the holding portion is opened with respect to the first locking portion. According to this structure, the engagement between the engagement portion of the holding portion and the first locking portion is released, and the holding portion is moved in the direction in which the holding portion is opened, whereby the engagement portion of the holding portion can engage with the second locking portion in the state where the pressing of the transfer body to the image carrier is released.

The aforementioned image forming apparatus according to this aspect preferably further includes a bearing that holds a rotating shaft of the transfer body, the apparatus body preferably includes a guide portion that extends from the vicinity of the bearing to the side opposite to the pressing direction, and the transfer body is preferably detached from the apparatus body to the side opposite to the pressing direction by slidingly moving the bearing to the side opposite to the pressing direction through the guide portion. According to this structure, the transfer body fixed to the bearing can be slidingly moved simultaneously with the slide movement of the bearing to the side opposite to the pressing direction along the guide portion, and hence the transfer body can be easily detached from the apparatus body.

In this case, the bearing is preferably provided with a groove into which the guide portion is fitted, and the bearing is preferably slidingly movable along the guide portion in a state where the guide portion is fitted into the groove. According to this structure, releasing of a state where the bearing is guided by the guide portion can be significantly reduced or prevented by the groove.

In the aforementioned image forming apparatus in which the bearing is provided with the groove into which the guide portion is fitted, the guide portion is preferably shaped like a plate, and the bearing is preferably slidingly movable along the guide portion in a state where the guide portion shaped like a plate is fitted into the groove. According to this structure, the guide portion shaped like a plate can be easily fitted into the groove.

In the aforementioned image forming apparatus according to this aspect, the apparatus body preferably includes a casing that forms the outer shape of the apparatus body and a housing arranged inside the casing, and the transfer body is preferably mounted on the housing to be detachable from the housing to the side opposite to the pressing direction in which the transfer body presses the image carrier. According to this structure, no transfer body is provided closer to the casing, and hence it is not necessary to hold the transfer body. Thus, an increase of the thickness of the casing for an unnecessary increase of the strength of a portion closer to the casing can be significantly reduced or prevented.

The aforementioned image forming apparatus according to this aspect preferably further includes a holding portion that is arranged closer to the apparatus body and is capable of holding the pressing of the transfer body to the image carrier, a bearing that holds a rotating shaft of the transfer body, and a pressing spring that is provided between the holding portion and the bearing and presses the transfer body to the image carrier. According to this structure, the transfer body can be easily pressed to the image carrier by the pressing spring.

In this case, the holding portion and the bearing are preferably provided with a holding-portion-side boss and a bearing-side boss, respectively, the pressing spring preferably includes a coiled pressing spring, a first end of the coiled pressing spring is preferably guided by the holding-portion-side boss, and a second end of the coiled pressing spring is preferably guided by the bearing-side boss. According to this structure, the pressing spring can easily expand and contract along the pressing direction.

In the aforementioned image forming apparatus in which the holding portion and the bearing are provided with the holding-portion-side boss and the bearing-side boss, respectively, the first end and the second end thereof are preferably fixed by fitting the coiled pressing spring onto the holding-portion-side boss and the bearing-side boss. According to this structure, the holding portion, the bearing, the transfer body supported by the bearing, and the pressing spring can be unified.

In this case, the holding portion is preferably detachable from the apparatus body, and the holding portion is preferably detached from the apparatus body in a state where the holding portion, the bearing, the transfer body, and the pressing spring fixed to the holding-portion-side boss and the bearing-side boss are unified. According to this structure, workability for replacing the transfer body can be improved as compared with the case where the holding portion, the pressing spring, the bearing, and the transfer body are detached separately.

In the aforementioned image forming apparatus including the pressing spring, the holding portion preferably includes a pair of holding portions on a first side and a second side in the rotation axis direction of the transfer body, and the pressing spring preferably includes pressing springs provided between the pair of holding portions and the bearings. According to this structure, the pressing of the transfer body to the imager carrier can be stably held unlike the case where one pressing spring is provided.

In the aforementioned image forming apparatus including the pressing spring, the holding portion preferably includes an opening through which the arrangement of the pressing spring is checked. According to this structure, the arrangement of the pressing spring with respect to the holding portion can be easily checked.

In the aforementioned image forming apparatus according to this aspect, the transfer body is preferably mounted on the apparatus body to be detachable obliquely downward from the apparatus body to the side opposite to the pressing direction in which the transfer body presses the image carrier in a state where the apparatus body is placed on a horizontal plane. According to this structure, the transfer body can be detached from the apparatus body with small power unlike the case where the transfer body is detached upward.

### Effect of the Invention

According to the present invention, as hereinabove described, the image forming apparatus in which the transfer body can be easily replaced without unnecessarily increasing the strength of the cover member or the like that forms the outer shape of the apparatus body can be provided.

### BRIEF DESCRIPTION OF THE DRAWINGS

FIG. 1 A schematic view showing the overall structure of a laser printer according to a first embodiment of the present invention.

FIG. 2 A perspective view showing the arrangement of a transfer roller and a photoreceptor drum in a housing of the laser printer according to the first embodiment of the present invention.

FIG. 3 A diagram showing a state where the transfer roller is pressed to the photoreceptor drum in the laser printer according to the first embodiment of the present invention.

FIG. 4 A diagram showing a state where a holding portion is opened in the laser printer according to the first embodiment of the present invention.

FIG. 5 A diagram for illustrating a slide mechanism constituted by a bearing and a guide portion of the laser printer according to the first embodiment of the present invention.

FIG. 6 A diagram showing a state where a transfer roller is pressed to a photoreceptor drum in a laser printer according to a second embodiment of the present invention.

FIG. 7 A diagram showing a state where an engagement portion of a holding portion is locked by a locking portion (second locking portion) in the laser printer according to the second embodiment of the present invention.

FIG. 8 A diagram showing a state where the holding portion is opened in the laser printer according to the second embodiment of the present invention.

FIG. 9 A diagram showing a state where a transfer roller is pressed to a photoreceptor drum in a laser printer according to a third embodiment of the present invention.

FIG. 10 A diagram showing a state where a holding portion is opened in the laser printer according to the third embodiment of the present invention.

### MODES FOR CARRYING OUT THE INVENTION

Embodiments embodying the present invention are hereinafter described on the basis of the drawings.

### First Embodiment

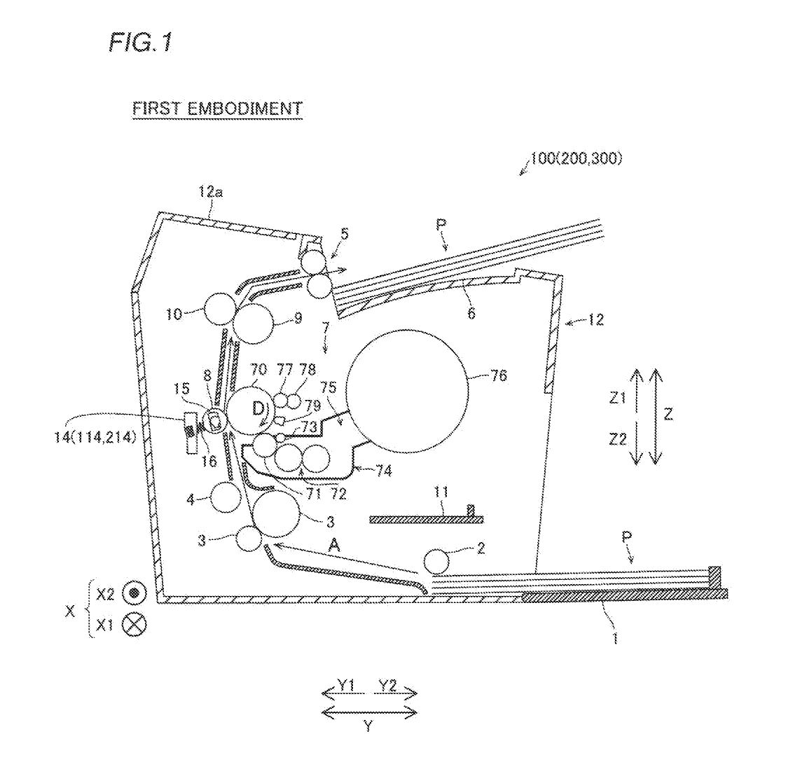

The structure of a laser printer 100 according to a first embodiment of the present invention is now described with reference to FIGS. 1 to 5.

The laser printer 100 according to the first embodiment of the present invention includes a paper feed tray 1 into which paper P is loaded to be fed, a take-up roller 2 configured to take up the paper P loaded into the paper feed tray 1 into the laser printer 100, a pair of transport rollers 3 configured to transport the paper P to a printing position, a feed roller 4 configured to send the paper P to the printing position, and a pair of paper discharge rollers 5 configured to discharge the paper P to a paper discharge tray 6, as shown in FIG. 1. The laser printer 100 also includes a photoreceptor drum 70, a developing device 7 configured to print an image on the paper P, and a transfer roller 8 configured to transfer an image that the developing device 7 carries to the paper P. The laser printer 100 includes a fuser roller 9 configured to heat the paper P so as to fix the image and a pressing roller 10 configured to press the paper P to the fuser roller 9. The laser printer 100 further includes a manual feed tray 11 configured to load the paper P manually fed by a user. In the laser printer 100, the paper P is transported through a transport path shown by arrow A. The laser printer 100 is an example of the “image forming apparatus” in the present invention. The transfer roller 8 is an example of the “transfer body” in the present invention. The photoreceptor drum 70 is an example of the “image carrier” in the present invention.

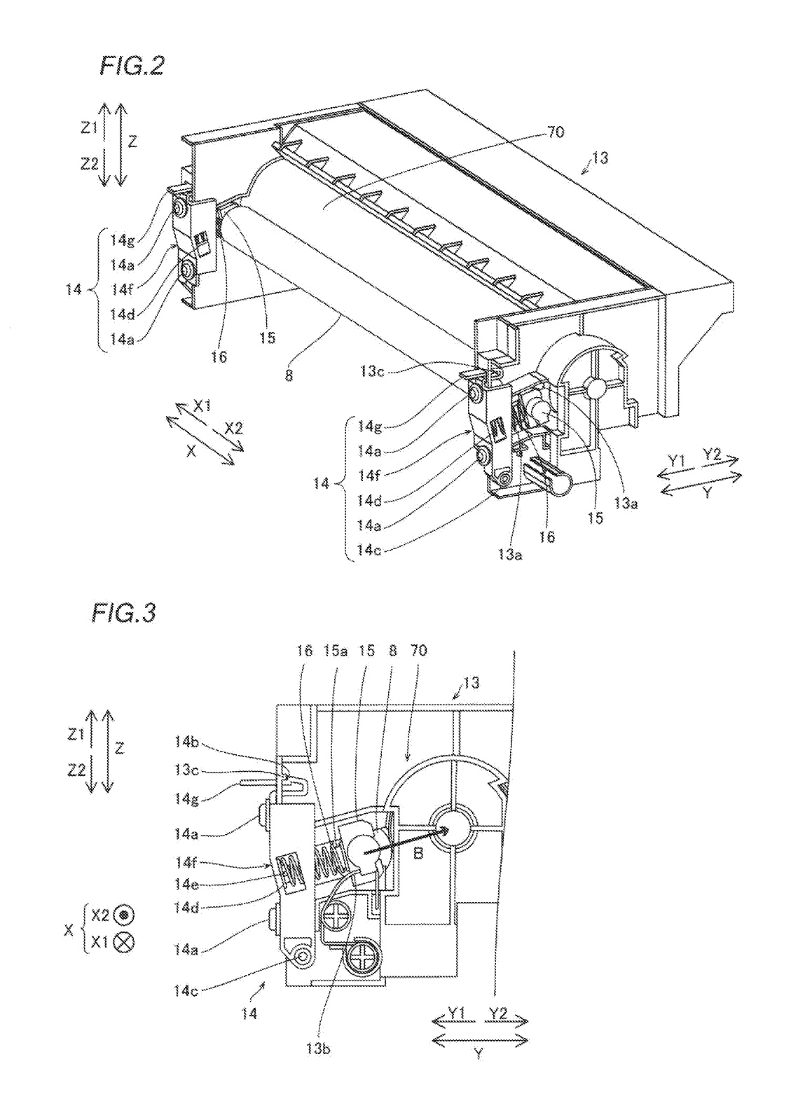

The laser printer 100 includes a casing 12 that forms the outer shape of the laser printer 100 and a housing 13 (see FIG. 2) arranged inside the casing 12, on which each component of the laser printer 100 can be mounted. More specifically, a printer body of the laser printer 100 is constituted by the casing 12 and the housing 13. In the laser printer 100, a rear cover 12a provided on a portion of the casing 12 is openable and closable.

According to the first embodiment, in the housing 13 of the laser printer 100, the transfer roller 8 and the photoreceptor drum 70 are arranged along a direction X, as shown in FIG. 2. The transfer roller 8 is arranged to face the photoreceptor drum 70. The transfer roller 8 is configured to be pressed toward the photoreceptor drum 70.

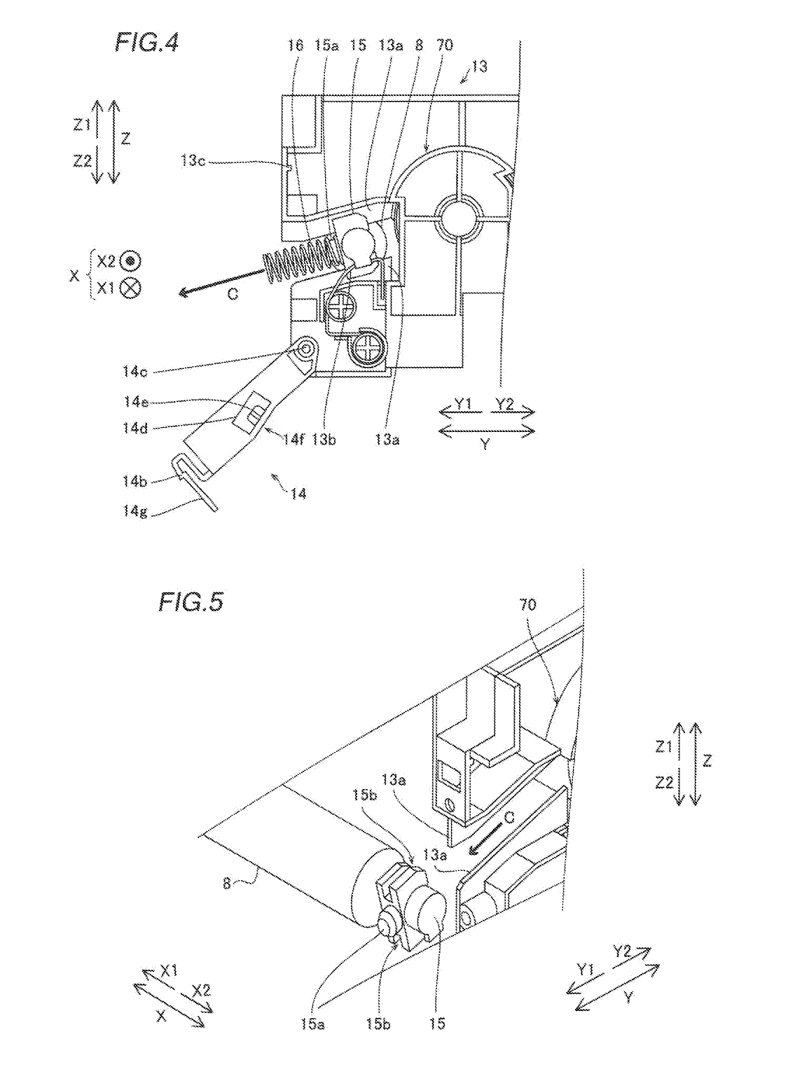

The housing 13 includes holding portions 14 that hold the pressing of the transfer roller 8 to the photoreceptor drum 70 in the vicinity of both ends of the transfer roller 8 in the direction X, a pair of bearings 15 that support a rotating shaft (not shown) of the transfer roller 8, and coiled pressing springs 16 that are provided between the holding portions 14 and the bearings 15 and press the transfer roller 8 to the photoreceptor drum 70. The housing 13 is formed with guide portions 13a that extend along arrow C (see FIG. 4) opposite to a pressing direction (along arrow B) from the vicinity of the bearings 15. The housing 13 further includes a voltage application portion 13b (see FIG. 3) configured to positively charge the transfer roller 8.

According to the first embodiment, the holding portions 14 each include two fixing screws 14a configured to fix a holding portion 14 to the housing 13, an engagement portion 14b configured to engage with a locking portion 13c of the housing 13, and a rotation portion 14c configured to rotate the holding portion 14 to a Y1 side, as shown in FIG. 3. The holding portions 14 each also include an opening 14d through which the arrangement of a pressing spring 16 is checked, and a boss 14e configured to guide the pressing spring 16. FIG. 3 shows the pressing of the transfer roller 8 to the photoreceptor drum 70. The boss 14e is an example of the “holding-portion-side boss” in the present invention.

Ends of the pressing springs 16 on a Y2 side are configured to be guided (positioned) by bosses 15a of the bearings 15. The pressing springs 16 are configured to press the transfer roller 8 to the photoreceptor drum 70 through the bearings 15 by pressing the bearings 15 along arrow B in a compressed state. Thus, the pressing of the transfer roller 8 to the photoreceptor drum 70 is maintained, and an image can be printed on the paper P. Furthermore, ends of the coiled pressing springs 16 on a Y1 side are configured to be guided (positioned) by bosses 14e of the holding portions 14. The pressing springs 16 are configured to press pressed regions 14f of the holding portions 14 to a side (Y1 side) opposite to the pressing direction. The bosses 15a are examples of the “bearing-side boss” in the present invention.

The holding portions 14 support the ends of the coiled pressing springs 16 on the Y1 side by the pressed regions 14f and each can hold the compressed pressing spring 16 by the two fixing screws 14a and the engagement portion 14b. The holding portions 14 each are configured to release the engagement between the engagement portion 14b and the locking portion 13c by elastically deforming a handle portion 14g provided integrally with the engagement portion 14b in a direction Z2. The holding portions 14 each are configured to be opened to the side (along arrow C) opposite to the pressing direction (along arrow B) by releasing the engagement of the engagement portion 14b after the fixing screw 14a is detached.

According to the first embodiment, the holding portions 14 each are configured to be opened to the side opposite to the pressing direction, using the rotation portion 14c as a rotation center, as shown in FIG. 4. The pressing springs 16 are configured to release the pressing of the transfer roller 8 to the photoreceptor drum 70 by the opening of the holding portions 14. The transfer roller 8 is configured to be detachable from the housing 13 to the Y1 side (along arrow C) opposite to the pressing direction, to which the holding portions 14 are opened in a state shown in FIG. 4. More specifically, the transfer roller 8 is mounted on the laser printer 100 to be detachable obliquely downward from the laser printer 100 to the side opposite to the pressing direction in which the transfer roller 8 presses the photoreceptor drum 70 in a state where the laser printer 100 is placed on a horizontal plane.

The transfer roller 8 is configured to be detached from the housing 13 by slide movement of the bearings 15 along arrow C on the Y1 side along the guide portions 13a in a state where the transfer roller 8 is held by the bearings 15 that hold the unshown rotating shaft, as shown in FIG. 5. The guide portions 13a each are shaped like a plate. Specifically, the bearings 15 are slidingly movable along arrow C along the guide portions 13a by fitting the guide portions 13a each shaped like a plate, provided on the housing 13 into grooves 15b provided in the bearings 15. FIG. 5 shows the detachment of the transfer roller 8 from the housing 13. The developing device 7 includes the photoreceptor drum 70 configured to perform printing by causing toner to adhere to the paper P, a developing roller 71 configured to supply the toner to the photoreceptor drum 70, a toner feed roller 72 configured to feed the toner to the developing roller 71, and a restricting roller 73, as shown in FIG. 1. All of the developing roller 71, the toner feed roller 72, and the restricting roller 73 are arranged in a toner carrying region 74.

The developing device 7 also includes a toner supply passage 75 that supplies the toner to the toner carrying region 74 and a toner cartridge 76 that stores new toner. The developing device 7 further includes a charging roller 77 arranged to face the photoreceptor drum 70, configured to negatively charge a surface of the photoreceptor drum 70, a cleaning portion 78 configured to recover the toner moved from the photoreceptor drum 70 to a surface of the charging roller 77, and a laser emitting portion 79 configured to apply laser light to a photoreceptor drum 70.

The surface of the photoreceptor drum 70 is configured to be negatively charged by the charging roller 77. In the photoreceptor drum 70 during printing, the laser emitting portion 79 first applies laser light to a prescribed surface of the photoreceptor drum 70 along the rotational direction D of the photoreceptor drum 70, and negative charge is removed from a surface of a position subjected to the application of the laser light. Thus, an electrostatic latent image is formed on a region of the surface of the photoreceptor drum 70 from which the negative charge is removed. In the developing roller 71, on the other hand, the toner caused to adhere to the surface by the restricting roller 73 is frictionally charged to be negatively charged. Thereafter, the negatively charged toner supplied by the developing roller 71 adheres to the electrostatic latent image formed on the photoreceptor drum 70. Then, the voltage application portion 13b (see FIG. 3) applies a voltage, and the negatively charged toner is moved from the photoreceptor drum 70 toward the positively charged transfer roller 8, whereby the toner is adsorbed (transferred) to the paper P arranged between the transfer roller 8 and the photoreceptor drum 70. Consequently, printing is performed on the paper P on the basis of the electrostatic latent image formed on the photoreceptor drum 70.

After the negative charge is removed from the surface of the photoreceptor drum 70, the charging roller 77 recovers toner remaining on the surface of the photoreceptor drum 70, and the outer peripheral surface of the photoreceptor drum 70 is uniformly negatively charged again. Then, the cleaning portion 78 recovers toner adhering to the surface of the charging roller 77. Thus, the laser printer 100 according to the first embodiment of the present invention is configured.

According to the first embodiment, the following effects can be obtained.

More specifically, according to the first embodiment, as hereinabove described, the transfer roller 8 is mounted on the housing 13 to be detachable from the housing 13 along arrow C opposite to the pressing direction (along arrow B) in which the transfer roller 8 presses the photoreceptor drum 70, whereby the transfer roller 8 can be detached from the inside of the laser printer 100 without moving the position of the photoreceptor drum 70, and hence the transfer roller 8 can be easily replaced unlike the structure in which the transfer roller 8 is detached in the pressing direction to the photoreceptor drum 70 after the position of the photoreceptor drum 70 is moved. Furthermore, the transfer roller 8 can be directly detached from the housing 13 arranged in the laser printer 100, and hence it is not necessary to provide the transfer roller 8 on the rear cover 12a of the laser printer 100. Thus, an unnecessary increase of the strength of the rear cover 12a resulting from holding the transfer roller 8 can be significantly reduced or prevented.

According to the first embodiment, as hereinabove described, the laser printer 100 further includes the holding portions 14 arranged closer to the housing 13, capable of holding the pressing of the transfer roller 8 to the photoreceptor drum 70, and the transfer roller 8 is detachable from the housing 13 along arrow C opposite to the pressing direction by opening the holding portions 14 to the side opposite to the pressing direction. Thus, the holding portions 14 can be opened to the side opposite to the pressing direction of the transfer roller 8, and hence the transfer roller 8 can be easily replaced. Furthermore, the transfer roller 8 can be held in a prescribed position by the holding portions 14 arranged closer to the housing 13 as members separate from the housing 13, and hence it is not necessary for the rear cover 12a of the laser printer 100 to hold the transfer roller 8. In other words, it is not necessary to strongly form the rear cover 12a so as to hold the transfer roller 8, and hence an unnecessary increase of the strength of the rear cover 12a can be significantly reduced or prevented.

According to the first embodiment, as hereinabove described, the holding portions 14 are rotatably mounted on the housing 13, and the transfer roller 8 is detached from the housing 13 along arrow C opposite to the pressing direction by rotating the holding portions 14 to the side opposite to the pressing direction in which the transfer roller 8 presses the photoreceptor drum 70 about the rotation center of the rotation portion 14c. Thus, the holding portions 14 can be rotated to the side opposite to the pressing direction of the transfer roller 8, and hence the holding portions 14 can be opened by a simple mechanism. Thus, the transfer roller 8 can be easily detached from the housing 13.

According to the first embodiment, as hereinabove described, a pair of holding portions 14 are provided on a first side and a second side in the rotation axis direction of the transfer roller 8. Thus, the holding portions 14 can stably hold the pressing of the transfer roller 8 to the photoreceptor drum 70 unlike the case where one holding portion 14 is provided.

According to the first embodiment, as hereinabove described, the holding portions 14 each include the engagement portion 14b that engages with the locking portion 13c of the housing 13, and the transfer roller 8 is detached from the housing 13 along arrow C opposite to the pressing direction by releasing the engagement of the engagement portion 14b. Thus, the housing 13 and the holding portions 14 can be fixed to each other through the engagement portions 14b. Furthermore, the holding portions 14 can be opened by releasing the engagement of the engagement portions 14b, and hence the transfer roller 8 can be easily detached from the housing 13.

According to the first embodiment, as hereinabove described, the laser printer 100 is provided with the locking portions 13c that engage with the engagement portions 14b of the holding portions 14, and the holding portions 14 are provided with the handle portions 14g that are provided integrally with the engagement portions 14b and release the engagement between the engagement portions 14b and the locking portions 13c by elastic deformation. Thus, the engagement between the engagement portions 14b and the locking portions 13c can be easily released by the handle portions 14g.

According to the first embodiment, as hereinabove described, the pair of holding portions 14 are provided on the first side and the second side in the rotation axis direction of the transfer roller 8, and the engagement portion 14b is provided in each of the pair of holding portions 14. Thus, the pressing of the transfer roller 8 to the photoreceptor drum 70 can be stably held unlike the case where one holding portion 14 and one engagement portion 14b are provided.

According to the first embodiment, as hereinabove described, the laser printer 100 further includes the bearings 15 that hold the rotating shaft (not shown) of the transfer roller 8, the housing 13 includes the guide portions 13a formed to extend from the vicinity of the bearings 15 to the side opposite to the pressing direction, and the transfer roller 8 is detached from the housing 13 along arrow C opposite to the pressing direction by slidingly moving the bearings 15 to the side opposite to the pressing direction through the guide portions 13a. According to this structure, the transfer roller 8 fixed to the bearings 15 can be slidingly moved simultaneously with the slide movement of the bearings 15 to the side opposite to the pressing direction along the guide portions 13a, and hence the transfer roller 8 can be easily detached from the housing 13.

According to the first embodiment, as hereinabove described, the bearings 15 are provided with the grooves 15b into which the guide portions 13a are fitted, and the bearings 15 are slidingly movable along the guide portions 13a in a state where the guide portions 13a are fitted into the grooves 15b. Thus, release of a state where the bearings 15 are guided by the guide portions 13a can be significantly reduced or prevented by the grooves 15b.

According to the first embodiment, as hereinabove described, the guide portions 13a each are shaped like a plate, and the bearings 15 are slidingly movable along the guide portions 13a in the state where the guide portions 13a each shaped like a plate are fitted into the grooves 15b. Thus, the guide portions 13a each shaped like a plate can be easily fitted into the grooves 15b.

According to the first embodiment, as hereinabove described, the laser printer 100 includes the casing 12 that forms the outer shape of the laser printer 100 and the housing 13 arranged inside the casing 12, and the transfer roller 8 is mounted on the housing 13 to be detachable from the housing 13 to the side opposite to the pressing direction in which the transfer roller 8 presses the photoreceptor drum 70. Thus, no transfer roller 8 is provided on the rear cover 12a closer to the casing 12, and hence it is not necessary for the rear cover 12a to hold the transfer roller 8. Thus, an increase of the thickness of the casing for an unnecessary increase of the strength of the rear cover 12a of the casing 12 can be significantly reduced or prevented.

According to the first embodiment, as hereinabove described, the pressing springs 16 that press the transfer roller 8 to the photoreceptor drum 70 are provided between the holding portions 14 and the bearings 15. Thus, the transfer roller 8 can be easily pressed to the photoreceptor drum 70 by the pressing springs 16.

According to the first embodiment, as hereinabove described, the holding portions 14 and the bearings 15 are provided with the bosses 14e and the bosses 15a, respectively, and first ends of the coiled pressing springs 16 are guided by the bosses 14e while second ends thereof are guided by the bosses 15a. Thus, the pressing springs 16 can easily expand and contract along the pressing direction.

According to the first embodiment, as hereinabove described, the pair of holding portions 14 are provided on the first side and the second side in the rotation axis direction of the transfer roller 8, and the pressing springs 16 are provided between the pair of holding portions 14 and the bearings 15. Thus, the pressing of the transfer roller 8 to the photoreceptor drum 70 can be stably held unlike the case where one pressing spring 16 is provided.

According to the first embodiment, as hereinabove described, the holding portions 14 are provided with the openings 14d through which the arrangement of the pressing springs 16 is checked. Thus, the arrangement of the pressing springs 16 with respect to the holding portions 14 can be easily checked.

According to the first embodiment, as hereinabove described, the transfer roller 8 is mounted on the laser printer 100 to be detachable obliquely downward from the laser printer 100 to the side opposite to the pressing direction in which the transfer roller 8 presses the photoreceptor drum 70 in the state where the laser printer 100 is placed on the horizontal plane. Thus, the transfer roller 8 can be detached from the laser printer 100 with small power unlike the case where the transfer roller 8 is detached upward.

### Second Embodiment

A second embodiment is now described with reference to FIGS. 1 and 6 to 8. In this second embodiment, an example in which a housing 13 is further provided with other locking portions 113d capable of locking holding portions 114 even in a state where pressing of a transfer roller 8 to a photoreceptor drum 70 is released is described unlike the aforementioned first embodiment in which the locking portions 13c capable of locking the holding portions 14 in a state where the transfer roller 8 is pressed to the photoreceptor drum 70 each are provided in one place in the housing 13. The locking portions 113d are examples of the “second locking portion” in the present invention.

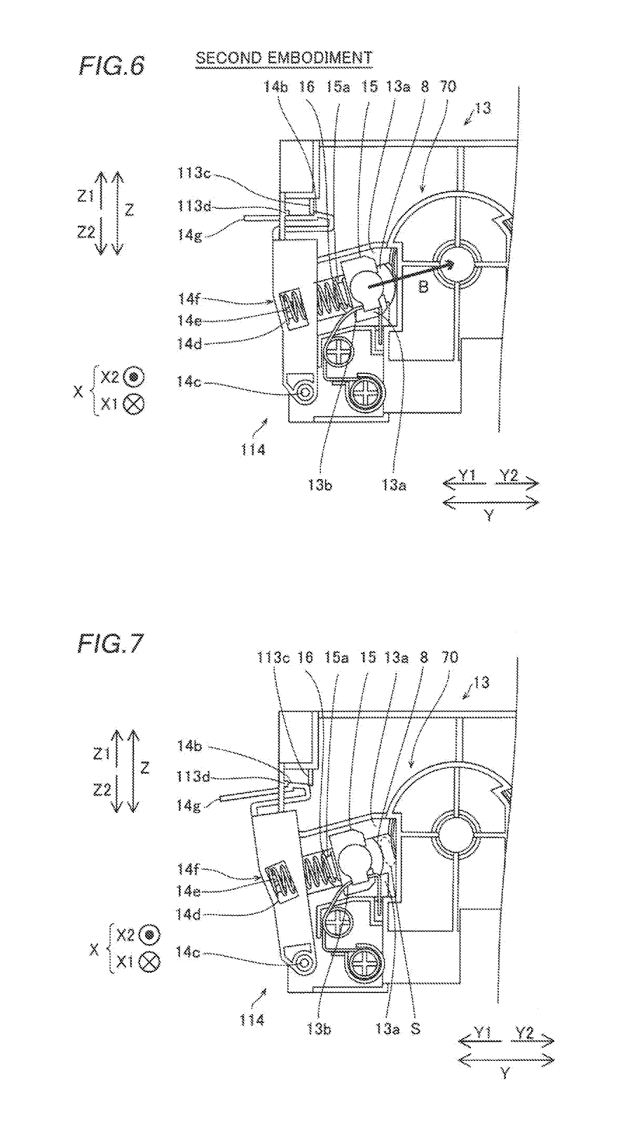

A laser printer 200 (see FIG. 1) according to the second embodiment of the present invention includes the photoreceptor drum 70, the transfer roller 8, the housing 13 including locking portions 113c and the locking portions 113d, and the holding portions 114 that can engage with the locking portions 113c and the locking portions 113d, as shown in FIG. 6. The laser printer 200 is an example of the “image forming apparatus” in the present invention. The locking portions 113c are examples of the “first locking portion” in the present invention.

According to the second embodiment, the holding portions 114 include engagement portions 14b configured to engage with the locking portions 113c and the locking portions 113d of the housing 13 and rotation portions 14c configured to rotate the holding portions 114 to a Y1 side, as shown in FIG. 6. FIG. 6 shows the pressing of the transfer roller 8 to the photoreceptor drum 70.

According to the second embodiment, the holding portions 114 is configured to be capable of holding the pressing force of pressing springs 16 received by pressed regions 14f by the engagement portions 14b when the locking portions 113c of the housing 13 engage with the engagement portions 14b. Furthermore, the holding portions 114 are configured to be capable of releasing the engagement between the engagement portions 14b and the locking portions 113c by elastically deforming handle portions 14g provided integrally with the engagement portions 14b in a direction Z2. Moreover, the holding portions 114 are configured to be rotated to a side opposite to a pressing direction by releasing the engagement of the engagement portions 14b.

The holding portions 114 are configured to engage with the locking portions 113d after releasing the engagement with the locking portions 113c and being rotated to the Y1 side, as shown in FIG. 7. Furthermore, the holding portions 114 are configured to release the pressing of the transfer roller 8 to the photoreceptor drum 70 when the engagement portions 14b engage with the locking portions 113d. The holding portions 114 are slightly rotated to the Y1 side along with shift in the engagement of the engagement portions 14b from engagement with the locking portions 113c to engagement with the locking portions 113d such that a small space S (shown by a broken line) is ensured between the transfer roller 8 and the photoreceptor drum 70.

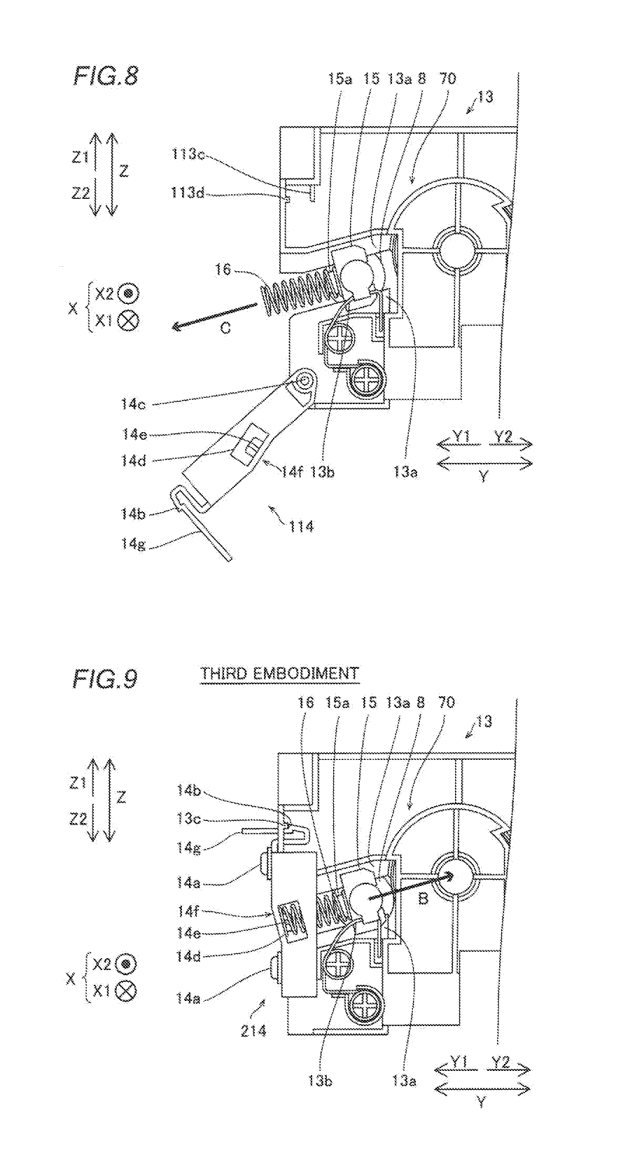

According to the second embodiment, the holding portions 114 are configured to be fully opened to the side opposite to the pressing direction by further rotating to the Y1 side from the state shown in FIG. 7 where the holding portions 114 engage with the locking portions 113d, as shown in FIG. 8. The transfer roller 8 is configured to be detachable from the housing 13 along arrow C opposite to the pressing direction, along which the holding portions 114 are opened, in a state shown in FIG. 8.

The remaining structure of the second embodiment is similar to that of the aforementioned first embodiment.

According to the second embodiment, the following effects can be obtained.

More specifically, according to the second embodiment, as hereinabove described, the transfer roller 8 is mounted on the housing 13 to be detachable from the housing 13 along arrow C opposite to the pressing direction (along arrow B) in which the transfer roller 8 presses the photoreceptor drum 70, whereby the transfer roller 8 can be detached from the inside of a printer body without moving the position of the photoreceptor drum 70, and hence the transfer roller 8 can be easily replaced as compared with the structure in which the transfer roller 8 is detached in the pressing direction to the photoreceptor drum 70 after the position of the photoreceptor drum 70 is moved. Furthermore, the transfer roller 8 can be detached from the housing 13, and hence it is not necessary to provide the transfer roller 8 on a rear cover 12a of the laser printer 200. More specifically, an unnecessary increase of the strength of the rear cover 12a resulting from holding the transfer roller 8 can be significantly reduced or prevented.

According to the second embodiment, as hereinabove described, the housing 13 includes the locking portions 113c that engage with the engagement portions 14b of the holding portions 114 and can lock the holding portions 114 in a state where the transfer roller 8 is pressed to the photoreceptor drum 70 and the locking portions 113d that engage with the engagement portions 14b of the holding portions 114 and can lock the holding portions 114 in the state where the pressing of the transfer roller 8 to the photoreceptor drum 70 is released. Thus, the locking portions 113d engage with the engagement portions 14b such that the small space S can be ensured between the transfer roller 8 and the photoreceptor drum 70, and hence the paper P held between the transfer roller 8 and the photoreceptor drum 70 can be easily pulled out when a jam of the paper P occurs in the laser printer 200 during transport.

According to the second embodiment, as hereinabove described, the locking portions 113d are arranged in a direction in which the holding portions 114 are opened with respect to the locking portions 113c. Thus, the engagement between the engagement portions 14b of the holding portions 114 and the locking portions 113c is released, and the holding portions 114 are moved in the direction in which the holding portions 114 are opened, whereby the engagement portions 14b of the holding portions 114 can engage with the locking portions 113d in the state where the pressing of the transfer roller 9 to the photoreceptor drum 70 is released.

The remaining effects of the second embodiment are similar to those of the aforementioned first embodiment.

### Third Embodiment

A third embodiment is now described with reference to FIGS. 1, 9, and 10. In this third embodiment, an example in which holding portions 214 are opened by detaching fixing screws 14a and engagement portions 14b is described unlike each of the aforementioned first and second embodiments in which the holding portions 14 (114) are opened using the rotation portions 14c as rotation centers.

A laser printer 300 (see FIG. 1) according to the third embodiment of the present invention includes a photoreceptor drum 70, a transfer roller 8, a housing 13, and the holding portions 214 mounted on the housing 13 by the fixing screws 14a and the engagement portions 14b, as shown in FIG. 9. The laser printer 300 is an example of the “image forming apparatus” in the present invention.

According to the third embodiment, the holding portions 214 include the fixing screws 14a configured to fix the holding portions 214 to the housing 13 and the engagement portions 14b configured to engage with locking portions 13c of the housing 13, as shown in FIG. 9. The holding portions 214 include openings 14d through which the arrangement of pressing springs 16 is checked and bosses 14e configured to guide the pressing springs 16. FIG. 9 shows the pressing of the transfer roller 8 to the photoreceptor drum 70.

Ends of the pressing springs 16 on a Y2 side are configured to be guided (positioned) by bosses 15a of bearings 15. The inner diameter of a coil of each of the coiled pressing springs 16 is substantially equal to the outer diameter of each of the bosses 15a. In other words, the ends of the pressing springs 16 on the Y2 side are configured to be fixed to the bearings 15 by being fitted onto the bosses 15a. The pressing springs 16 are configured to be capable of pressing the transfer roller 8 through the bearings 15 by pressing the bearings 15 in a pressing direction (along arrow B). Ends of the pressing springs 16 on a Y1 side are configured to be guided (positioned) by the bosses 14e of the holding portions 214. The inner diameter of the coil of each of the pressing springs 16 is substantially equal to the outer diameter of each of the bosses 14e. In other words, the ends of the pressing springs 16 on the Y1 side are configured to be fixed to the holding portions 214 by being fitted onto the bosses 14e. More specifically, one member in which the holding portions 214 are coupled to the bearings 15 and the transfer roller 8 through the pressing springs 16 is formed in a state where both ends of the pressing springs 16 in a direction Y are fixed to the bosses 14e and the bosses 15a.

The holding portions 214 are configured to be capable of releasing the engagement between the engagement portions 14b and the locking portions 13c by elastically deforming handle portions 14g provided integrally with the engagement portions 14b in a direction Z2. Each of the holding portions 214 is configured to be openable to a side opposite to the pressing direction by releasing the engagement of the engagement portions 14b after two fixing screws 14a are detached.

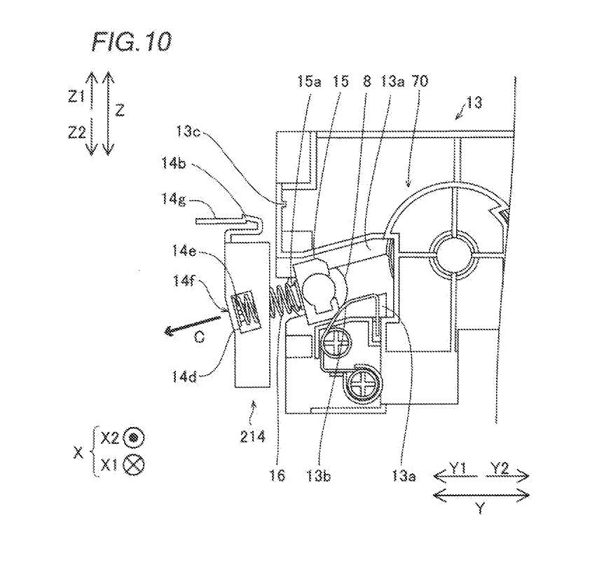

According to the third embodiment, the holding portions 214 are configured to be opened to the side opposite to the pressing direction of the pressing spring 16 by being detached from the housing 13, as shown in FIG. 10. The holding portions 214 are further pulled along arrow C in an opened state such that the bearings 15 coupled through the pressing springs 16 are slidingly moved along guide portions 13a together with the pressing springs 16. Then, the transfer roller 8 is slidingly moved along arrow C together with the bearings 15 and is detached from the housing 13. Thus, the pressing springs 16, the bearings 15, and the transfer roller 8 can be detached in unison from a body of the housing 13 simultaneously with the detachment of the holding portions 214, and hence workability for replacing the transfer roller 8 can be improved as compared with the case where these components are detached separately. More specifically, the holding portions 214 are configured to be detachable from the laser printer 300.

The remaining structure of the third embodiment is similar to that of the aforementioned first embodiment.

According to the third embodiment, the following effects can be obtained.

More specifically, according to the third embodiment, as hereinabove described, the transfer roller 8 is mounted on the housing 13 to be detachable from the housing 13 along arrow C opposite to the pressing direction (along arrow B) in which the transfer roller 8 presses the photoreceptor drum 70, whereby the transfer roller 8 can be detached from the inside of the laser printer 300 without moving the position of the photoreceptor drum 70, and hence the transfer roller 8 can be easily replaced unlike the structure in which the transfer roller 8 is detached in the pressing direction to the photoreceptor drum 70 after the position of the photoreceptor drum 70 is moved. Furthermore, the transfer roller 8 can be detached from the housing 13 arranged in the laser printer 300, and hence it is not necessary to provide the transfer roller 8 on a rear cover 12a of the laser printer 300. Thus, an unnecessary increase of the strength of the rear cover 12a resulting from holding the transfer roller 8 can be significantly reduced or prevented.

According to the third embodiment, as hereinabove described, first ends and second ends of the coiled pressing springs 16 are fitted onto the bosses 14e and the bosses 15a to be fixed. Thus, the holding portions 214, the bearings 15, the transfer roller 8 supported by the bearings 15, and the pressing springs 16 can be unified.

According to the third embodiment, as hereinabove described, the holding portions 214 are detachable from the laser printer 300 and are detached from the laser printer 300 in a state where the holding portions 214, the bearings 15, the transfer roller 8, and the pressing springs 16 fixed to the bosses 14e and the bosses 15a are unified. Thus, workability for replacing the transfer roller 8 can be improved as compared with the case where the holding portions 214, the pressing springs 16, the bearings 15, and the transfer roller 8 are detached separately.

The remaining effects of the third embodiment are similar to those of the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the example of applying the image forming apparatus according to the present invention to the laser printer 100 (200, 300) has been shown in each of the aforementioned first to third embodiments, the present invention is not restricted to this. According to the present invention, the image forming apparatus may be applied to an apparatus such as a combined machine in which a scanner, a printer function, etc. are unified.

While the example in which the holding portions 14 (114, 214) hold the pressing springs 16 and the transfer roller 8 is detached from the housing 13 through the opened space formed by opening the holding portions 14 (114, 214) to the side opposite to the pressing direction has been shown in each of the aforementioned first to third embodiments, the present invention is not restricted to this. According to the present invention, any structure may be used so far as the transfer roller 8 can be detached to the side opposite to the pressing direction. For example, the locking portions 114d capable of releasing the pressing of the transfer roller 8 to the photoreceptor drum 70 may be provided as in the second embodiment, and a detachment mechanism for the transfer roller 8 that can detach the transfer roller 8 in a direction other than along arrow C without detaching the holding portions after releasing the pressing may be provided.

While the example of arranging the rotation portions 14c below the engagement portions 14b has been shown in each of the aforementioned first and second embodiments, the present invention is not restricted to this. According to the present invention, the rotation portions may be arranged above the pressing springs 16, the engagement portions may be arranged below the pressing springs 16, and the holding portions may be rotated upward.

While the example of providing one engagement portion 14b in each of the holding portions 14 (114, 214) has been shown in each of the aforementioned first to third embodiments, the present invention is not restricted to this. According to the present invention, two or more engagement portions may be provided in each of the holding portions 14. Alternatively, two or more engagement portions may be provided, and the pressing force of the pressing springs 16 may be held only by the engagement portions.

While the example in which both the fixing screws 14a and the engagement portions 14b support the pressing force of the pressing springs 16 has been shown in each of the aforementioned first to third embodiments, the present invention is not restricted to this. According to the present invention, the pressing force of the pressing springs 16 may be held only by the fixing screws 14a.

While the example of configuring a slide mechanism by providing the concave grooves 15b in the bearings 15 and providing the convex guide portions 13a in the housing 13 has been shown in each of the aforementioned first to third embodiments, the present invention is not restricted to this. According to the present invention, any structure may be used so far as the bearings 15 slide and the transfer roller 8 is detachable from the housing 13. For example, concave grooves may be provided in the housing 13, and convex portions slidingly movable along these grooves may be provided in the bearings 15.

### DESCRIPTION OF REFERENCE NUMERALS

8 transfer roller (transfer body)
12 casing
13 housing
13a guide portion
13c, 113c, 113d locking portion
14, 114, 214 holding portion
14b engagement portion
14e boss (holding-portion-side boss)
15 bearing
15a boss (bearing-side boss)
15b groove
16 pressing spring
70 photoreceptor drum (image carrier)
100, 200, 300 laser printer (image forming apparatus)
113c locking portion (first locking portion)
113d locking portion (second locking portion)

1. An image forming apparatus (100, 200, 300) comprising:
an apparatus body;
an image carrier (70) rotatably provided in the apparatus body; and
a transfer body (8) that is arranged in the apparatus body and transfers an image of the image carrier to a recording medium while pressing the image carrier through the recording medium, wherein
the transfer body is mounted on the apparatus body to be detachable from the apparatus body to a side opposite to a pressing direction in which the transfer body presses the image carrier.

2. The image forming apparatus according to claim 1, further comprising a holding portion (14, 114, 214) that is arranged closer to the apparatus body and is capable of holding pressing of the transfer body to the image carrier, wherein
the transfer body is detachable from the apparatus body to the side opposite to the pressing direction by opening the holding portion to the side opposite to the pressing direction.

3. The image forming apparatus according to claim 2, wherein
the holding portion is rotatably mounted on the apparatus body, and
the transfer body is detached from the apparatus body to the side opposite to the pressing direction by rotating the holding portion to the side opposite to the pressing direction of the transfer body to the image carrier about a rotation center.

4. The image forming apparatus according to claim 2, wherein
the holding portion includes a pair of holding portions on a first side and a second side in a rotation axis direction of the transfer body.

5. The image forming apparatus according to claim 2, wherein
the holding portion includes an engagement portion (14b) that engages with the apparatus body, and
the transfer body is detached from the apparatus body to the side opposite to the pressing direction by releasing engagement of the engagement portion.

6. The image forming apparatus according to claim 5, wherein
the apparatus body includes a locking portion (13c, 113c, 113d) that engages with the engagement portion of the holding portion, and
the holding portion further includes a handle portion (14g) that is provided integrally with the engagement portion and releases engagement between the engagement portion and the locking portion by elastic deformation.

7. The image forming apparatus according to claim 5, wherein
the holding portion includes a pair of holding portions on a first side and a second side in a rotation axis direction of the transfer body, and
the engagement portion is provided in each of the pair of holding portions.

8. The image forming apparatus according to claim 5, wherein
the apparatus body includes a first locking portion (113c) that engages with the engagement portion of the holding portion and is capable of locking the holding portion in a state where the transfer body is pressed to the image carrier and a second locking portion (113d) that engages with the engagement portion of the holding portion and is capable of locking the holding portion in a state where the pressing of the transfer body to the image carrier is released.

9. The image forming apparatus according to claim 8, wherein
the second locking portion is arranged in a direction in which the holding portion is opened with respect to the first locking portion.

10. The image forming apparatus according to claim 1, further comprising a bearing (15) that holds a rotating shaft of the transfer body, wherein
the apparatus body includes a guide portion (13a) that extends from a vicinity of the bearing to the side opposite to the pressing direction, and
the transfer body is detached from the apparatus body to the side opposite to the pressing direction by slidingly moving the bearing to the side opposite to the pressing direction through the guide portion.

11. The image forming apparatus according to claim 10, wherein
the bearing is provided with a groove (15b) into which the guide portion is fitted, and
the bearing is slidingly movable along the guide portion in a state where the guide portion is fitted into the groove.

12. The image forming apparatus according to claim 11, wherein
the guide portion is shaped like a plate, and
the bearing is slidingly movable along the guide portion in a state where the guide portion shaped like the plate is fitted into the groove.

13. The image forming apparatus according to claim 1, wherein
the apparatus body includes a casing (12) that forms an outer shape of the apparatus body and a housing (13) arranged inside the casing, and
the transfer body is mounted on the housing to be detachable from the housing to the side opposite to the pressing direction in which the transfer body presses the image carrier.

14. The image forming apparatus according to claim 1, further comprising:
a holding portion (14, 114, 214) that is arranged closer to the apparatus body and is capable of holding pressing of the transfer body to the image carrier;
a bearing (15) that holds a rotating shaft of the transfer body; and
a pressing spring (16) that is provided between the holding portion and the bearing and presses the transfer body to the image carrier.

15. The image forming apparatus according to claim 14, wherein
the holding portion and the bearing are provided with a holding-portion-side boss (14e) and a bearing-side boss (15a), respectively,
the pressing spring includes a coiled pressing spring, and
a first end of the coiled pressing spring is guided by the holding-portion-side boss, and a second end of the coiled pressing spring is guided by the bearing-side boss.

16. The image forming apparatus according to claim 15, wherein
the first end and the second end thereof are fixed by fitting the coiled pressing spring onto the holding-portion-side boss and the bearing-side boss.

17. The image forming apparatus according to claim 16, wherein
the holding portion is detachable from the apparatus body, and
the holding portion is detached from the apparatus body in a state where the holding portion, the bearing, the transfer body, and the pressing spring fixed to the holding-portion-side boss and the bearing-side boss are unified.

18. The image forming apparatus according to claim 14, wherein
the holding portion includes a pair of holding portions on a first side and a second side in a rotation axis direction of the transfer body, and
the pressing spring includes pressing springs provided between the pair of holding portions and the bearings.

19. The image forming apparatus according to claim 14, wherein
the holding portion includes an opening (14d) through which arrangement of the pressing spring is checked.

20. The image forming apparatus according to claim 1, wherein
the transfer body is mounted on the apparatus body to be detachable obliquely downward from the apparatus body to the side opposite to the pressing direction in which the transfer body presses the image carrier in a state where the apparatus body is placed on a horizontal plane.
